(19) United States
(12) Patent Application Publication
(10) Pub. No.: US 2009/0307479 A1
(43) Pub. Date: Dec. 10, 2009

(54) COMPUTER EXECUTION SYSTEM FOR STARTING PROGRAM QUICKLY AND METHOD THEREOF

(75) Inventors: CHIH-YI CHEN, TAIPEI (TW); SHENG-FENG YANG, TAIPEI (TW); JUN-JIE LIAO, TAIPEI (TW)

Correspondence Address: ROSENBERG, KLEIN & LEE, 3458 ELLICOTT CENTER DRIVE-SUITE 101, ELLICOTT CITY, MD, 21043, US

(73) Assignee: ASUSTEK COMPUTER INC., TAIPEI (TW)

(21) Appl. No.: 12/418,791

(22) Filed: Apr. 6, 2009

(30) Foreign Application Priority Data
Jun. 6, 2008 (TW) 097121042

(51) Int. Cl. G06F 9/06; G06F 17/30

(52) U.S. Cl. 713/2; 707/7; 707/1; 707/E17.001

(57) ABSTRACT

A computer execution system and a method thereof for starting at least a program quickly after a computer is booted are provided. First, a file list is stored. The file list includes multiple file names of start files which are necessary when the program is started. When the computer is booted, the start files corresponding to the file names in the file list are retrieved from a low-speed storage device and stored in a high-speed storage device. Afterwards, when the program is started, it is executed by cooperating with the start files in the high-speed storage device. Thus, the program is started quickly. This not only saves a user's time in waiting, but also increases the working efficiency of the user.

### BACKGROUND OF THE INVENTION

1. Field of the Invention

The invention relates to a computer execution system and a method thereof and, more particularly, to a computer execution system for starting programs quickly and a method thereof.

2. Description of the Related Art

A computer such as a desktop computer, a notebook computer, a smart phone, a tablet computer and so on should be booted before they are operated. The basic input output system (BIOS) and the operation system (OS) are started during booting. Afterwards, when the computer finishes booting, a user is allowed to start various programs normally. The programs are word processing programs (such as the Word and the Word Pad), graphics editing programs (such as the Flash, the Paint and the Photoshop), spreadsheet programs (such as the Excel), presentation programs (such as the Power point), multimedia player programs (such as the Media player and the Real player) and other various programs.

However, with the increase of human requirements, the programs are more and more complex, and the quantity of data is larger. The programs include more and more files. Therefore, when a program needs to be executed after the computer is booted, the files of the program are retrieved from a low-speed storage device such as a hard disk and stored in a high-speed storage device such as a dynamic random access memory (DRAM) by a processor. However, since these processes are performed at the same time, this not only consumes many hardware resources, but also wastes much time in starting the program. To a user, the long time for waiting makes the work inefficient.

The user often upgrades the hardware directly. For example, the processor, the memory unit and other hardware are upgraded. However, this consumes much cost. In another method, some programs often used are preset to be started along with the booting process of the computer when the operation system is started. However, this consumes much time during booting, and actually the programs are not needed every time. Therefore, the distribution of the resources and efficiency when the computer is booted and the program is started still need to be improved now.

### BRIEF SUMMARY OF THE INVENTION

The invention provides a computer execution system which can start programs quickly and efficiently after the computer is booted and a method thereof. Thus a user's time in waiting for the program to be started is saved.

The invention relates to a computer execution method for starting a program quickly. That is, at least a program is started quickly after the computer is booted. The program may include multiple start files and multiple program files. The start files and the program files of the program are stored in a low-speed storage device originally.

The computer execution method includes the steps as follows. First, a file list is stored. The file list includes file names of the start files which need to be started quickly. Then, when the computer is started, the start files corresponding to the file names in the file list are retrieved from the low-speed storage device and stored in a high-speed storage device. Afterwards, when the program is started, it is executed quickly by cooperating with the start files in the high-speed storage device.

Therefore, the computer execution system and the method thereof are used to start and execute programs quickly and efficiently by retrieving some necessary start files used when the programs are started and storing the retrieved start files in the high-speed storage device during booting the computer. Thus, the user's time in waiting for starting the program is saved.

These and other features, aspects and advantages of the present invention will become better understood with regard to the following description, appended claims, and accompanying drawings.

### BRIEF DESCRIPTION OF THE DRAWINGS

FIG. 1 is a related schematic diagram showing the computer execution system in an embodiment of the invention when the computer is booted;

FIG. 2 is a related schematic diagram showing the computer execution system in an embodiment of the invention when the programs are started;

FIG. 3 is a related schematic diagram showing that the file list is modified in an embodiment of the invention;

FIG. 4 is a related schematic diagram showing that the programs are preset to be started quickly in an embodiment of the invention;

FIG. 5 is a related schematic diagram showing that the file names in the file list are sorted in an embodiment of the invention ; and

FIG. 6 is a flow chart showing the computer execution method in an embodiment of the invention.

### DETAILED DESCRIPTION OF THE EMBODIMENTS

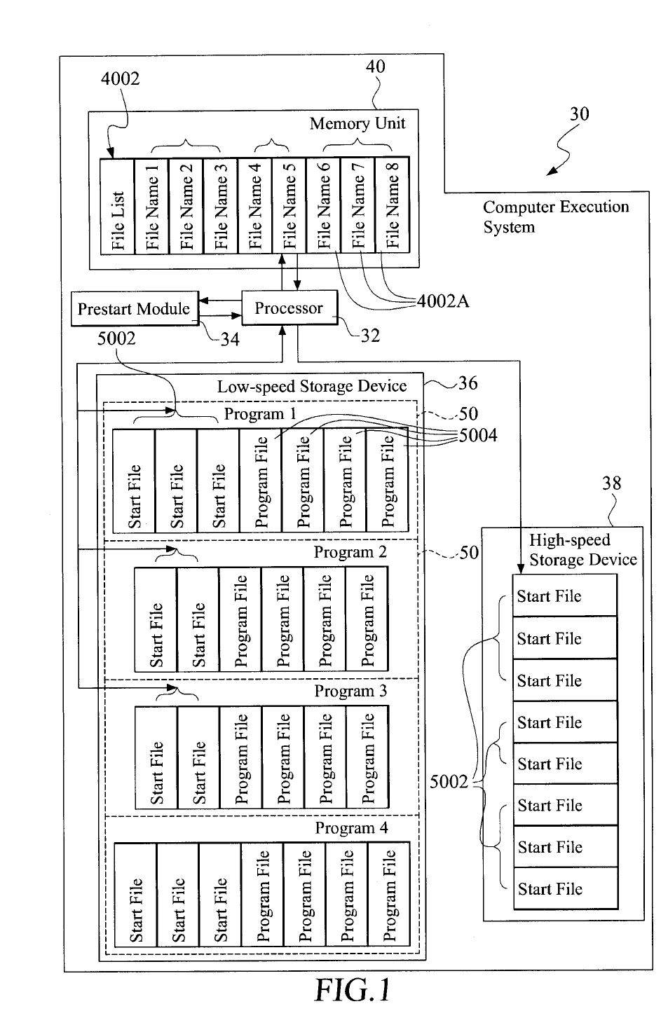

FIG. 1 is a related schematic diagram showing the computer execution system 30 in an embodiment of the invention when a computer is booted. As shown in FIG. 1, the invention relates to a computer execution system 30 for starting a program 50 quickly. That is, at least the program 50 is started quickly after the computer is booted. For example, the computer is a desktop computer, a notebook computer, a smart phone or a tablet computer. The basic input output system (BIOS) and the operation system (OS) are started during booting. The program 50 is a word processing program (such as the Word or the Word pad), a graphics editing programs (such as the Flash, the Paint or the Photoshop), or a multimedia player program (such as the Media player or the Real player).

The computer execution system 30 mainly includes a processor 32, a low-speed storage device 36, a memory unit 40, a high-speed storage device 38 and a prestart module 34.

The programs 50 usually include multiple start files 5002 and multiple program files 5004. In FIG. 1, a program 1, a program 2, a program 3 and a program 4 are shown. These programs 50 are stored in the low-speed storage device 36 originally. Each program 50 includes multiple start files 5002 and multiple program files 5004.

A user often uses the program 1, the program 2 and the program 3, and he or she does not often use the program 4. Therefore, all the file names 4002A of the start files 5002 of the program 1, the program 2 and the program 3 are stored in a file list 4002 of the memory unit 40 beforehand by the processor 32.

As shown in FIG. 1, a file name 1, a file name 2 and a file name 3 stand for the file names 4002A of all the start files 5002 of the program 1. A file name 4 and a file name 5 stand for the file names 4002A of all the start files 5002 of the program 2. A file name 6, a file name 7 and a file name 8 stand for the file names 4002A of the start files 5002 of the program 3. These start files 5002 are necessary files used when the programs 50 are started and executed.

When the computer is booted, the prestart module 34 retrieves the start files 5002 corresponding to the file names 4002A in the file list 4002 in the memory unit 40 from the low-speed storage device 36 via the processor 32 and stores the retrieved start files 5002 in the high-speed storage device 38. Since the program 4 is not often used, the file names 4002A of the start files 5002 of the program 4 are not stored in the file list 4002 beforehand. Therefore, the start files 5002 of the program 4 are not loaded in the high-speed storage device 38. Thus, the task executed in the computer execution system 30 in the invention when the computer is booted is finished.

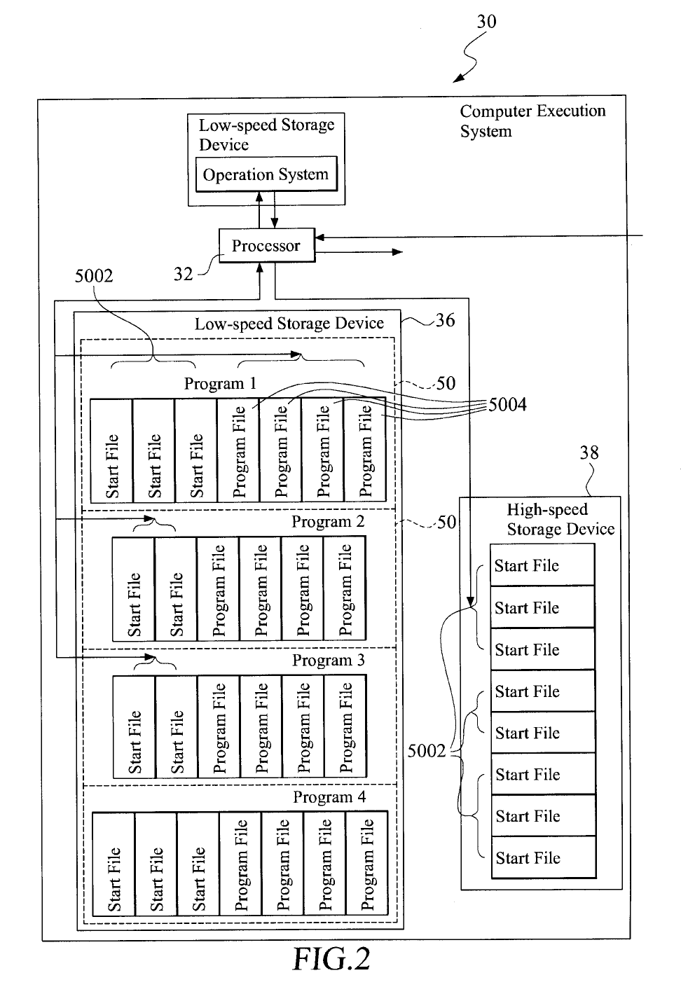

FIG. 2 is a related schematic diagram showing the computer execution system 30 in an embodiment of the invention when the programs 50 are started. As shown in FIG. 2, after the computer is booted, when the user wants to start the programs 50, the programs 50 are executed by cooperating with the start files 5002 in the high-speed storage device 38.

The operating system 64 at that moment is run. If the user wants to start the program 1, the three related start files 5002 in the program 1 in the high-speed storage device 38 are executed first via the processor 32 and the operating system 64. If other program files 5004 (unnecessary files when the programs 50 are started) need to be executed, they are retrieved from the low-speed storage device 36 by the processor 32.

Thus, after the user boots the computer, the programs 50 which need to be used are started in a short time. This saves much time in waiting. Both the program 2 and the program 3 can be started in this mode. However, since the start files 5002 of the program 4 are not in the high-speed storage device 38 when the computer is booted, the computer execution system 30 cannot save the time for the program 4 to be started. Thus, the program 4 is started in a normal speed.

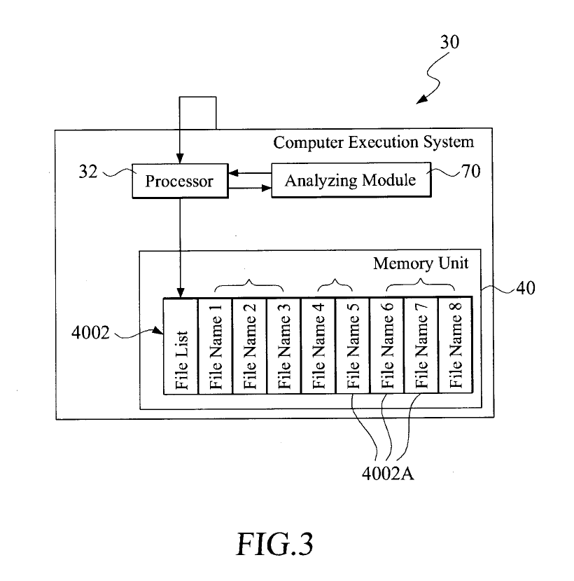

FIG. 3 is a related schematic diagram showing that the file list 4002 is modified in an embodiment of the invention. As shown in FIG. 3, in the computer execution system 30, a program tracer 70 is used to record the file names 4002A of the start files 5002 used when the programs 50 are started in the file list 4002. The chosen programs 50 are deliberately executed first. When the processor 32 executes the programs 50, the start files 5002 are started one by one. At that moment, the program tracer 70 stores the file names 4002A of the started start files 5002 in the file list 4002 of the memory unit 40 via the processor 32.

As shown in FIG. 3, the chosen programs 50 are the program 1, the program 2 and the program 3, and therefore, the file names 1 to 8 corresponding to the eight start files 5002 are stored in the file list 4002 of the memory unit 40 after the program 1, the program 2 and the program 3 are started one by one.

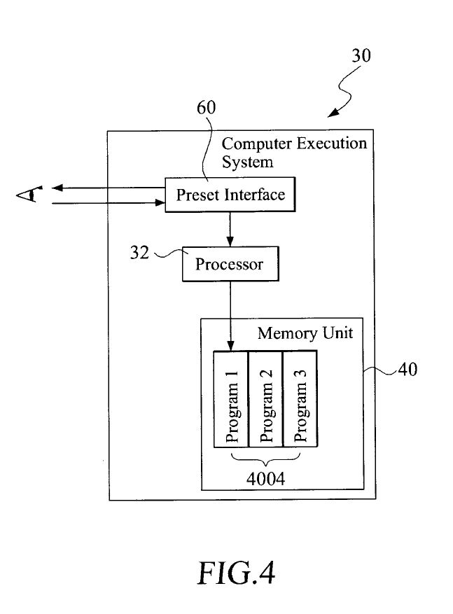

FIG. 4 is a related schematic diagram showing that the programs 50 are preset to be started in an embodiment of the invention. As shown in FIG. 4, in the computer execution system 30, the programs 50 are preset to be started quickly via a preset interface 60 when the computer is booted. In the embodiment, the programs 50 which are chosen to be started quickly are the program 1, the program 2 and the program 3. The user may store the names 4004 of the program 1, the program 2 and the program 3 in the memory unit 40 using the preset interface 60 via the processor 32 to allow the program tracer 70 to perform the comparing and referring process.

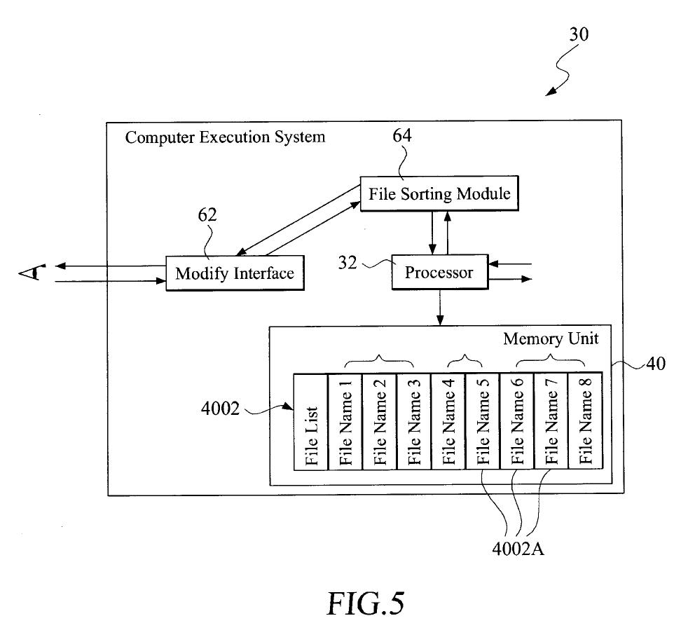

In addition, FIG. 5 is a related schematic diagram showing that the file names 4002A in the file list 4002 are sorted in an embodiment of the invention. As shown in FIG. 5, the computer execution system 30 may further include a file sorting module 64.

When the start files 5002 are multiple, the file sorting module 64 deletes the start files 5002 with the same file names 4002A in the start files 5002 in the file list 4002 through the processor 32 to reduce the loads of the prestart module 34 and the processor 32 when the programs 50 are executed.

When the start files 5002 are multiple, the file sorting module 64 sorts the file names 4002A of the start files 5002 in the file list 4002 through the processor 32. Generally, they are sorted according to the start order of the start files 5002 when the programs 50 are executed. This is benefit for starting and executing programs efficiently when the programs 50 are executed after the computer is booted.

After the file names 4002A of the start files 5002 in the file list 4002 are sorted, the file sorting module 64 is controlled through a modifying interface 62 to modify the order of the file names 4002A of the start files 5002 in the file list 4002 to meet the habit of the user. Modifying the order of the file names 4002A is modifying the order of starting the programs 50. For example, a user uses the Photoshop program first every time he or she boots the computer due to the job demand, he or she can modify the order of file names 4002A in the memory unit 40 through the file sorting module 64 and the processor 32 using the modifying interface 62. The start files 5002 relating to the Photoshop program may be put ahead to allow the user to enter the working mode quickly after the computer is booted.

In addition, when the start files 5002 are multiple, the file sorting module 64 arranges the file names 4002A of the start files 5002 which belong to the same program 50 close to each other in the file list 4002 through the processor 32. Thus, the programs 50 are ready to be started quickly and efficiently one by one.

Furthermore, the modules such as the prestart module 34, the program tracer 70, the file sorting module 64 and so on are compiled in scripting program language (such as the Perl, the Shell script, the Python and so on). The modules cooperate with the related electronic components and the circuits to achieve the functions of the modules. The preset interface 60 and the modifying interface 62 are, for example, window browsers. That is, they are the visual operating interfaces between human and the computer.

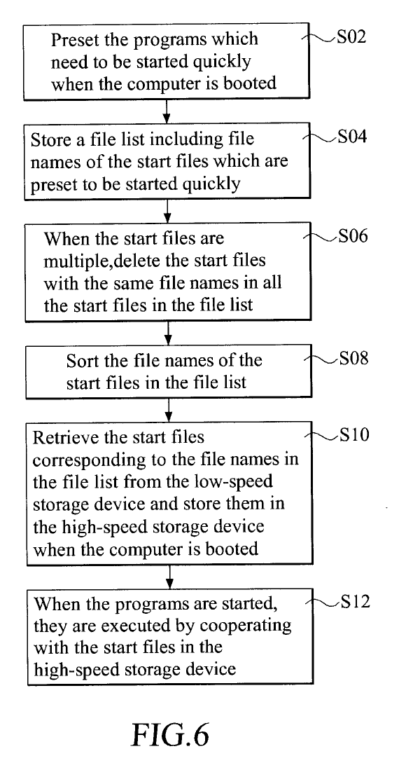

FIG. 6 is a flow chart showing the computer execution method in an embodiment of the invention. The invention is also a computer execution method for starting programs 50 quickly. That is, at least one program 50 is started quickly after the computer is booted. The programs 50 usually include multiple start files 5002 and multiple program files 5004. The start files 5002 and the program files 5004 of the programs 50 are stored in a low-speed storage device 36 originally. The computer execution method includes the following steps.

In step S02, the programs 50 which need to be started quickly when the computer is booted are preset through a preset interface 60.

In step S04, a file list 4002 including the file names 4002A of the start files 5002 in the programs 50 which are preset to be started quickly is stored. The file list 4002 records the file names 4002A of the start files 5002 used when the programs 50 are started using a program tracer 70.

In step S06, when the start files 5002 are multiple, the start files 5002 with the same file names 4002A in the start files 5002 are deleted in the file list 4002.

In step S08, the file names 4002A of the start files 5002 in the file list 4002 are sorted.

In step S10, when the computer is booted, the start files 5002 corresponding to the file names 4002A in the file list 4002 are retrieved from the low-speed storage device and stored in a high-speed storage device 38.

In step S12, when the programs 50 are started, the programs 50 are executed quickly by cooperating with the start files 5002 in the high-speed storage device 38.

Therefore, in the computer execution system 30 and the method thereof in the invention, the necessary start files 5002 used when the programs 50 are started are stored in the high-speed storage device 38 to start and execute the programs 50 quickly and efficiently after booting to save the time for waiting for the programs 50 to be started.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A computer execution method for starting at least a program including a start file and a program file quickly after a computer is booted, wherein the start file and the program file of the program are stored in a low-speed storage device, the computer execution method comprising the steps of:
storing a file list including a file name of the start file;
retrieving the start file corresponding to the file name in the file list from the low-speed storage device and storing the retrieved start file in a high-speed storage device when the computer is booted; and
executing the program by cooperating with the start file in the high-speed storage device when the program is started.

2. The computer execution method according to claim 1, wherein the file list records the file name of the start file used when the program is started using a program tracer.

3. The computer execution method according to claim 1, wherein the program which needs to be started quickly is preset via a preset interface.

4. The computer execution method according to claim 1, wherein when the start files are multiple, the start files with the same file names in the file list are further deleted from the start files.

5. The computer execution method according to claim 1, wherein when the start files are multiple, the file names of the start files in the file list are further sorted.

6. The computer execution method according to claim 5, wherein after the file names of the start files in the file list are sorted, the order of the file names of the start files in the file list are modified via an modifying interface.

7. The computer execution method according to claim 1, wherein when the start files are multiple, the file names of the start files which belong to the same program in the file list are arranged close to each other.

8. A computer execution system, which starts at least a program including a start file and a program file quickly after a computer is booted, the computer execution system further comprising:
a low-speed storage device for storing the start file and the program file of the program;
a memory unit for storing a file list including a file name of the start file;
a high-speed storage device; and
a prestart module used to retrieve the start file corresponding to the file name in the file list of the memory unit from the low-speed storage device and store the retrieved start file in the high-speed storage device when the computer is booted;
wherein when the program is started after the computer is booted, the program is executed by cooperating with the start file in the high-speed storage device.

9. The computer execution system according to claim 8, wherein the file list records the file name of the start file used when the program is started using a program tracer.

10. The computer execution system according to claim 8, wherein the program which needs to be started quickly when the computer is booted is preset via a preset interface.

11. The computer execution system according to claim 8, wherein the computer execution system further comprises a file sorting module, and when the start files are multiple, the file sorting module deletes the start files with the same file names in the start files in the file list.

12. The computer execution system according to claim 8, further comprising a file sorting module, wherein when the start files are multiple, the file sorting module further sorts the file names of the start files in the file list.

13. The computer execution system according to claim 12, wherein after the file names of the start files in the file list are sorted, the file sorting module is controlled by an modifying interface to modify the order of the file names of the start files in the file list.

14. The computer execution system according to claim 8, further comprising a file sorting module, wherein when the start files are multiple, the file sorting module further arranges the file names of the start files which belong to the same program in the file list close to each other.
